(19) United States
(12) Patent Application Publication
(10) Pub. No.: US 2007/0033246 A1
(43) Pub. Date: Feb. 8, 2007

(54) Thin metal film uninterruptable power supply system

(75) Inventors: Don Buckley, Poway, CA (US); Lance Chandler, Gig Harbor, CA (US)

Correspondence Address: WALLACE G. WALTER, 5726 CLARENCE AVE, ALEXANDRIA, VA, 22311-1008, US

(73) Assignee: Poweready, Inc., Milpitas, CA (US)

(21) Appl. No.: 10/778,892

(22) Filed: Feb. 13, 2004

Related U.S. Application Data
(60) Provisional application No. 60/447,550, filed on Feb. 13, 2003.

(51) Int. Cl. G06F 15/16

(52) U.S. Cl. 709/200

(57) ABSTRACT

A basic computer system of the present invention includes a CPU electrically connected to an un-interruptible power supply (UPS). The UPS includes a Control and Memory block 106 that is attached to a battery pack containing power cells, such as thin metal film power cells. The number of cells may vary depending on the power density requirements of the UPS, and the voltages which are necessary.

### RELATED APPLICATION

This application claims the benefit of priority to U.S. Provisional Patent Application No. 60/447,550 filed Feb. 13, 2003, and currently co-pending.

### FIELD OF THE INVENTION

The present invention relates generally to a TMF Technology (Thin Metal Film) UPS (Un-interruptible power supply) systems. More specifically, the present invention pertains to a rechargeable cell battery for auxiliary power in computer systems to facilitate the shutdown of the computer system.

### BACKGROUND OF THE INVENTION

Power supplies are standard equipment in nearly all computers, and while these devices are available in a variety of types and configurations, all power supplies require a separate battery to provide electrical energy to the computer for emergency shutdown procedures. A typical situation requiring such an emergency shutdown would be in the event of a power failure in which the computer no longer receives any input power.

Un-interruptible Power Supplies (UPS) devices have been introduced in recent years to provide a solution to those situations where the input power falls below an acceptable voltage level (often called “brown-outs”), and where the input power is unexpectedly terminated (often called “black-outs”). These UPS devices are installed between the electrical line input and a load such as a computer, and typically contain a battery that is maintained in a charged state, with a monitor circuit that monitors the current condition of the electrical line input. When either a brown-out or black-out occurs, the monitor circuit draws electrical energy from the battery in order to continue to provide the necessary energy to the load, thereby providing an un-interrupted power source.

While UPS devices are indeed useful, they often provide only a brief period of back-up power. This is particularly problematic when the computer is not attended during the brown-out or black-out such that the computer can be shut-down during the limited back-up power period.

Another problem with currently available UPS devices is that these power systems are typically external to the computer system, and require user intervention in order to safely and adequately shut down a computer system during an input line power interruption. In circumstances where the computer operator is away from the computer during the power crises, the computer will not be shut down properly resulting in possible damage to the system, loss of critical data, or other symptoms of an improper power-off procedure.

One attempt to address the need for a separate battery for the powering off of a computer was disclosed in U.S. Pat. No.______.

In light of the above, the present invention key points are:
Rapid current technology f′800 A/sec (TMF technology);
Ultra small footprint;
Can be placed internal to a standard desktop system, or external;
Complete shut down (based on large power deployment ) in a software based system shutdown; the shutdown may be transparent with the complete and proper closure of all active windows.
safe shutdown for computer with brown-out or complete loss of power
lower power level (cf.) shutdown

### SUMMARY OF THE INVENTION

The un-interruptible power system of the present invention may include a USB-Interconnect-mechanism, driven through software to initiate shutdown procedure.

Typical Power conditioning, such as IEEE/NEWA standards, may be implemented in the un-interruptible power system taking into account line conditions, such as low voltage conditions, and high voltage spikes.

The operation of the un-interruptible power system may be dependent on programmable conditions including an operational matrix. For instance, power conditions may be used, in combination with an operational matrix, to determine particular shutdown parameters.

A typical operational matrix might include criteria such as:

if power drops out for t=1-2 min
line conditioner may operate for several seconds
aging of cell; number of cells

S/W select (lookup table) to determine proper operational characteristics:
Power regulators
level of operation
user configurable
automation—no user action required (may be optional)
auto configuration through BIOS reading.

Matrix
Interval increment 15 seconds—brownout/conditions
Power Regulators (# watts)
SUSPEND/HIBERNATE (UL power)/continue/power down
Manufacturer/model of computer
time to shut down
   (max # windows)
   Clock speed (MHZ)

### DESCRIPTION OF A PREFERRED EMBODIMENT

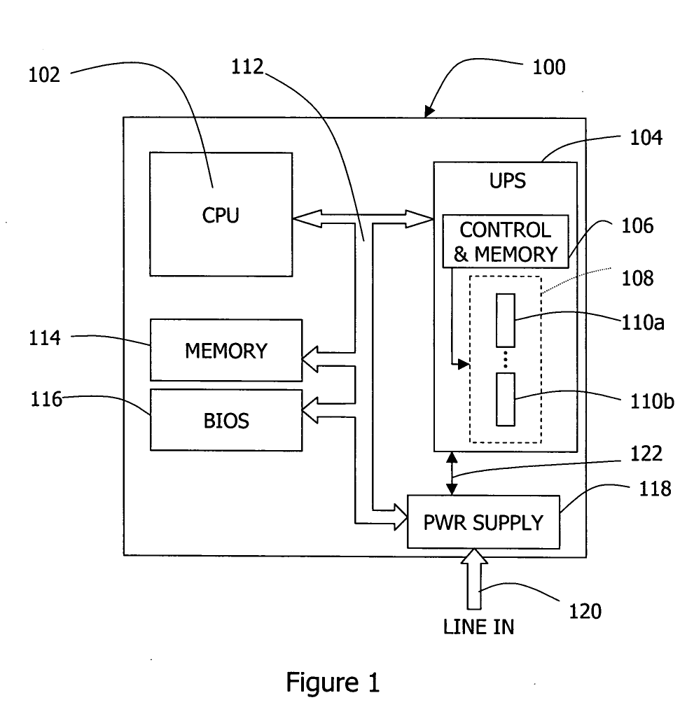

Referring to FIG. 1, a basic computer system of the present invention is shown and generally designated 100. Computer system 100 includes a CPU 102 electrically connected to an un-interruptible power supply (UPS) 104. The UPS 104 of the present invention includes a Control and Memory block 106 that is attached to a batter pack 106 containing power cells 110a and 110b, such as thin metal film power cells. The number of cells 110 may vary depending on the power density requirements of the UPS, and the voltages which are necessary.

A data buss 112 provides electrical connection between CPU 102, UPS 104, Memory 114, BIOS 116 and Power Supply 118. In this configuration, the operation of the present invention may include a software control system operating within the CPU and receiving data from UPS 104 including battery conditions, such as level of charge, operational matrix information from memory 114, and perhaps set-up information regarding the computer system 100 from BIOS 116.

Power supply 118 receives a line input 120 from a power source, such as a 120 VAC line input or a DC power source such as external or internal batteries. Electrical interconnect 122 provides an electrical connection between UPS 104 and power supply 118 such that the UPS may monitor the condition of line input 120, efficiency or proper operation of the power supply 118. This monitoring will provide Control and Memory 106 with near instantaneous information regarding the occurrence of a fault condition resulting in action being taken by the UPS to properly shut down the system.

It is to be appreciated that other configurations may be implemented in the present invention by those skilled in the art without departing from the scope of the present invention. Also, while aspects of the operation and control of the present invention have been disclosed herein, it is to be appreciated that these aspects are merely exemplary of a preferred embodiment, and are not intended as a limitation of the scope of the present invention.

1. An uninterruptable power supply system, comprising:
a CPU;
a control and memory block in electrical communication with a battery pack; and
a means for said control and memory block to control the operation of said CPU.
